(19) United States
(12) Patent Application Publication
(10) Pub. No.: US 2026/0268562 A1
(43) Pub. Date: Sep. 10, 2026

(54) DIFFUSION-BASED MOTION STYLIZATION USING STYLE-CONTENT CROSS FUSION

(71) Applicant: Roblox Corporation, San Mateo, CA (US)

(72) Inventors: Mubbasir Turab KAPADIA, San Mateo, CA (US); Joseph LIU, San Mateo, CA (US); Young Yoon LEE, San Mateo, CA (US); Yizhak BEN-SHABAT, San Mateo, CA (US); Victor B. ZORDAN, Riverside, CA (US); Ziyu GUO, San Mateo, CA (US)

(73) Assignee: Roblox Corporation, San Mateo, CA (US)

(21) Appl. No.: 19/293,754

(22) Filed: Aug. 7, 2025

Related U.S. Application Data
(60) Provisional application No. 63/768,132, filed on Mar. 6, 2025.

(51) Int. Cl. G06T 13/00; G06T 5/70

(52) U.S. Cl. CPC G06T 13/00; G06T 5/70; G06T 2207/10016; G06T 2207/20081

(57) ABSTRACT

Some implementations relate to methods, systems, and computer readable media for generating stylized motion sequences using a diffusion model with style-content cross fusion. According to some aspects, an input motion sequence is obtained that represents a sequence of skeletal poses over a number of frames and generating a noisy motion representation based on the input motion sequence. A style input is obtained, including one or more from the group comprising a style motion sequence, a text prompt, an image, an audio signal, a video clip, and any combination thereof. The noisy motion representation is iteratively refined using the diffusion model over a number of timesteps. At each timestep, a denoised motion sequence is estimated by performing style-content cross fusion. A final motion representation is selected from the last timestep to generate a stylized motion sequence, which is then provided for use in a virtual environment.

### CROSS-REFERENCE TO RELATED APPLICATIONS

This application claims priority to U.S. Provisional Patent Application No. 63/768,132, filed Mar. 6, 2025, and titled “DIFFUSION-BASED MOTION STYLIZATION USING STYLE-CONTENT CROSS FUSION,” the entire contents of which are incorporated by reference herein.

### TECHNICAL FIELD

This document relates generally to motion generation in computer graphics and animation, and more particularly but not exclusively, relates to methods, systems, and computer-readable media to generate stylized motion sequences.

### BACKGROUND

Techniques for generating stylized motion sequences in animation and computer graphics face significant challenges in balancing motion realism, style preservation, and computational efficiency. Traditional motion editing techniques include manual adjustments by animators, who modify skeletal keyframes or apply procedural transformations to alter movement styles. While effective, manual motion editing is time-consuming, requires domain expertise, and may not generalize well across different motion styles. Deep learning-based motion synthesis techniques have been developed to automate motion generation. The approaches rely on predefined motion templates or neural networks trained on limited datasets.

Diffusion-based motion generation has emerged as a promising approach for producing high-quality, temporally coherent motion sequences. Diffusion models iteratively refine an initial noisy representation into a structured output, enabling them to capture complex motion dynamics while generating diverse and realistic animations. Diffusion-based motion models primarily focus on content preservation rather than style transfer. Some models attempt to incorporate style through dual-branch architectures, where separate network components process content and style independently. While the architectures can modify motion sequences, they introduce redundant parameters (leading to higher model size and thereby, high computational cost), increased training complexity (and correspondingly, higher computational cost for model training), and potential inconsistencies in motion quality due to the separation of style and content representations.

Current approaches for stylized motion generation struggle with multimodal style conditioning. Motion diffusion models rely on direct motion references as style inputs, requiring an explicit style motion sequence for training and inference. The reliance restricts the flexibility of the diffusion models, as users seeking stylized motion generation may not have access to a corresponding motion reference (for the target style). Some approaches attempt to introduce text-based style descriptions, but these lack alignment between motion and textual embeddings, resulting in weak style transfer. Additionally, such techniques do not incorporate potential style sources such as images, video, or audio.

Another challenge in motion diffusion models is enabling physical plausibility and temporal consistency in the generated motion sequences. The motion sequences generated by current models may include motion artifacts, discontinuities, or unrealistic joint movements, especially when applying high-variance style transformations. Some techniques introduce post-processing constraints to mitigate the issues, but such constraints include usage of additional computational resources. Additionally, current approaches do not effectively regulate velocity and acceleration constraints during diffusion, leading to unnatural transitions between frames.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Various implementations described herein relate to methods, systems, and computer-readable media to generate stylized motion sequences using a diffusion model with style-content cross fusion.

According to one aspect, a computer-implemented method includes obtaining an input motion sequence that represents a sequence of skeletal poses over a number of frames. The computer-implemented method further includes generating a noisy motion representation based on the input motion sequence. The computer-implemented method further includes obtaining a style input representing a motion style, wherein the style input includes one or more from the group comprising a style motion sequence, a text prompt, an image, an audio signal, a video clip, and any combination thereof. The computer-implemented method further includes iteratively refining the noisy motion representation using a trained diffusion model over a number of timesteps, wherein the iterative refinement includes, at each timestep: estimating, by the trained diffusion model, a denoised motion sequence based on the noisy motion representation, the style input, and the timestep, wherein estimating the denoised motion sequence includes performing style-content cross fusion, the style-content cross fusion including: normalizing a feature representation of the style input based on a feature representation of the noisy motion representation; and combining the normalized feature representation of the style input with the noisy motion representation; obtaining an updated motion representation as the noisy motion representation based on the denoised motion sequence and a motion representation obtained at a previous timestep; and updating the timestep. The computer-implemented method further includes generating a stylized motion sequence by selecting a final motion representation corresponding to a last timestep of the iterative refinement.

In some implementations, performing the style-content cross fusion includes applying a statistical transformation via cross-normalization between the style input and the noisy motion representation.

In some implementations, the trained diffusion model includes a single-branch architecture that processes content and style features within a same latent space.

In some implementations, iteratively refining the noisy motion representation further includes applying a geometric guidance constraint that regulates velocity and acceleration values for the denoised motion sequence across timesteps.

In some implementations, iteratively refining the noisy motion representation further includes applying a contrastive loss function, where a similarity score between an embedding of the style input and an embedding of the updated motion representation computed using the loss function is higher than a similarity score between the embedding of the style input and the noisy motion representation. In some implementations, contrastive loss is applied during the training of style encoders to improve the separability and alignment of style representations across different modalities, such as motion, image, text, and audio. This facilitates effective cross-modal retrieval and consistent style conditioning; The diffusion model itself is trained using a denoising loss between the predicted noise and the true noise added to the latent motion representation at each timestep.

In some implementations, iteratively refining the noisy motion representation further includes modifying denoising outputs at one or more timesteps using classifier-free guidance and classifier-based guidance, where using the guidance adjusts the noisy motion representation to balance content fidelity and adherence to the style input.

In some implementations, the classifier-based guidance modifies the denoising outputs based on gradient signals derived from a pre-trained style feature extractor that evaluates similarity to the style input.

In some implementations, if the timestep is a first timestep, obtaining the updated motion representation is based only on the denoised motion sequence.

In some implementations, the computer-implemented method further includes providing the stylized motion sequence for use within a virtual environment.

According to another aspect, a system includes one or more processors and memory coupled to the one or more processors storing instructions that, when executed by the one or more processors, cause the one or more processors to perform operations including: obtaining an input motion sequence that represents a sequence of skeletal poses over a plurality of frames. The operations further include generating a noisy motion representation based on the input motion sequence. The operations further include obtaining a style input representing a motion style, where the style input includes one or more from the group including a style motion sequence, a text prompt, an image, an audio signal, a video clip, and any combination thereof. The operations further include iteratively refining the noisy motion representation using a trained diffusion model over a number of timesteps, where the iterative refinement comprises, at each timestep: estimating, by the trained diffusion model, a denoised motion sequence based on the noisy motion representation, the style input, and the timestep, where estimating the denoised motion sequence includes performing style-content cross fusion, the style-content cross fusion including: normalizing a feature representation of the style input based on a feature representation of the noisy motion representation; and combining the normalized feature representation of the style input with the noisy motion representation; obtaining an updated motion representation as the noisy motion representation based on the denoised motion sequence and a motion representation obtained at a previous timestep; and updating the timestep. The operations further include generating a stylized motion sequence by selecting a final motion representation corresponding to a last timestep of the iterative refinement.

In some implementations, performing the style-content cross fusion includes applying a statistical transformation via cross-normalization between the style input and the noisy motion representation.

In some implementations, the trained diffusion model includes a single-branch architecture that processes content and style features within a same latent space.

In some implementations, iteratively refining the noisy motion representation further includes applying a geometric guidance constraint that regulates velocity and acceleration values for the denoised motion sequence across timesteps.

In some implementations, iteratively refining the noisy motion representation further includes applying a contrastive loss function, where a similarity score between an embedding of the style input and an embedding of the updated motion representation computed using the loss function is higher than a similarity score between the embedding of the style input and the noisy motion representation. In some implementations, contrastive loss is applied during the training of style encoders to improve the separability and alignment of style representations across different modalities, such as motion, image, text, and audio. This facilitates effective cross-modal retrieval and consistent style conditioning. The diffusion model itself is trained using a denoising loss between the predicted noise and the true noise added to the latent motion representation at each timestep.

In some implementations, iteratively refining the noisy motion representation further includes modifying denoising outputs at one or more timesteps using classifier-free guidance and classifier-based guidance, where using the guidance adjusts the noisy motion representation to balance content fidelity and adherence to the style input.

According to another aspect, a non-transitory computer-readable medium with instructions stored thereon is provided that, when executed by a processor, cause the processor to perform operations. The operations include obtaining an input motion sequence that represents a sequence of skeletal poses over a number of frames. The operations further include generating a noisy motion representation based on the input motion sequence. The operations further include obtaining a style input representing a motion style, where the style input includes one or more from the group including a style motion sequence, a text prompt, an image, an audio signal, a video clip, and any combination thereof. The operations further include iteratively refining the noisy motion representation using a trained diffusion model over a number of timesteps, wherein the iterative refinement includes, at each timestep: estimating, by the trained diffusion model, a denoised motion sequence based on the noisy motion representation, the style input, and the timestep, wherein estimating the denoised motion sequence includes performing style-content cross fusion, the style-content cross fusion including: normalizing a feature representation of the style input based on a feature representation of the noisy motion representation; and combining the normalized feature representation of the style input with the noisy motion representation; obtaining an updated motion representation as the noisy motion representation based on the denoised motion sequence and a motion representation obtained at a previous timestep; and updating the timestep. The operations further include generating a stylized motion sequence by selecting a final motion representation corresponding to a last timestep of the iterative refinement.

In some implementations, performing the style-content cross fusion includes applying a statistical transformation via cross-normalization between the style input and the noisy motion representation.

In some implementations, the trained diffusion model includes a single-branch architecture that processes content and style features within a same latent space.

In some implementations, iteratively refining the noisy motion representation further includes applying a geometric guidance constraint that regulates velocity and acceleration values for the denoised motion sequence across timesteps.

In some implementations, iteratively refining the noisy motion representation further includes applying a contrastive loss function, where a similarity score between an embedding of the style input and an embedding of the updated motion representation computed using the loss function is higher than a similarity score between the embedding of the style input and the noisy motion representation.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of the disclosure.

### BRIEF DESCRIPTION OF THE DRAWINGS

FIG. 1 is a diagram of an example system architecture to generate stylized motion sequences using a diffusion model with style-content cross fusion, in accordance with some implementations.

FIG. 2A is a flow diagram illustrating an example method 200 to provide stylized motion sequences using a diffusion model with style-content cross fusion, in accordance with some implementations.

FIG. 2B a flow diagram illustrating an example method 220 to provide iterative refinement of a noisy motion representation using a trained diffusion model, in accordance with some implementations.

FIG. 3 is a flow diagram illustrating an example method 300 to train a diffusion model to generate images, in accordance with some implementations.

FIG. 4 is a diagram illustrating examples of motion-guided stylization produced by a trained diffusion model, in accordance with some implementations.

FIG. 5 is a diagram illustrating examples of text-guided motion stylization produced by a trained diffusion model, in accordance with some implementations.

FIG. 6 is a diagram illustrating examples of style interpolation, in which a trained diffusion model generates motion sequences influenced by multiple textual style inputs, in accordance with implementations.

FIG. 7 is a diagram illustrating examples of multimodal motion stylization, where a trained diffusion model generates stylized motion sequences based on diverse types of style input, in accordance with some implementations.

FIG. 8 is a diagram illustrating an example architecture of a trained diffusion model configured to generate stylized motion sequences based on style and content inputs, in accordance with some implementations.

FIG. 9 is a block diagram that illustrates an example computing device, in accordance with some implementations.

### DETAILED DESCRIPTION

In the following detailed description, reference is made to the accompanying drawings, which form a part hereof. In the drawings, similar symbols identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation”, “an implementation”, “an example implementation”, “some implementations”, “aspect”, “aspects”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various implementations described herein relate to generating stylized motion sequences using a diffusion model with style-content cross fusion. Techniques include obtaining an input motion sequence representing skeletal poses across multiple frames and a style input comprising a motion sequence, text prompt, image, audio, video, or any combination thereof (e.g., text prompt + image, image + audio, motion sequence + image + audio, or various other combinations of two or more factors). The input motion sequence is transformed into a noisy motion representation, which is iteratively refined using a trained diffusion model over a series of timesteps. At each timestep, the diffusion model estimates a denoised motion sequence by applying style-content cross fusion, which includes normalizing a feature representation of the style input based on a feature representation of the noisy motion, and combining the normalized representation with the noisy motion representation.

Style-content cross fusion supports the integration of stylistic features while maintaining motion structure in the generated stylized motion sequence. In some implementations, the cross fusion operation includes applying a statistical transformation via cross-normalization between the style input and the noisy motion representation. In some implementations, a single-branch architecture may be used to process both content and style features in the same latent space. The output of each denoising operation is used to update the motion representation, which is passed to the next timestep in the diffusion. The final stylized motion sequence is selected from the motion representation obtained at the last timestep.

In some implementations, techniques applied during refinement include geometric guidance constraints and contrastive loss. Geometric guidance constraints regulate properties such as velocity and acceleration to encourage physically plausible motion and reduce artifacts. In some implementations, a contrastive loss function may be used to ensure that the similarity between embeddings of the style input and the updated motion representation is higher in comparison to the similarity between the style input and the original noisy motion. Guidance may be applied using classifier-free and classifier-based approaches. Classifier-based guidance may modify the denoising trajectory based on gradient signals from a pre-trained style feature extractor.

In some implementations, the stylized motion sequence can be provided for animation of avatars or characters within virtual environments. In some implementations, real-time or near-real-time avatar motion customization is supported based on multimodal style inputs. Developers of games and/or virtual experiences may use the stylized output to incorporate consistent motion of avatars or characters (or any other entity that is depicted with motion) effects across a range of styles and input types, without requiring traditional animation authoring tools. The stylized motion sequence can also be utilized in video games, motion picture motion transfer, or in any other context where stylized motion synthesis is used.

Some technical advantages of various features include enabling multimodal conditioning for stylized motion generation using a diffusion model. The approach supports conditioning signals in multiple formats, such as motion sequences, text prompts, audio, images, video clips, and any combinations thereof. Such flexibility provides compatibility with varied content pipelines and removes the reliance on motion-only style references. Conditioning with natural language or visual data sources broadens the range of stylized animation generation and enables intuitive control by users or developers.

Another technical advantage of some implementations is the use of a style-content cross fusion mechanism that preserves motion structure while injecting stylistic features. The fusion mechanism includes normalizing a feature representation of the style input based on a feature representation of the noisy motion and combining the two. The integration helps retain semantic consistency and reduces motion artifacts even when using abstract style inputs such as, e.g., short text prompts or low-quality reference videos.

Another technical advantage of some implementations is the use of geometric guidance constraints that maintain kinematic plausibility (realism) across the generated motion sequence. Velocity and acceleration values are regulated throughout the denoising, reducing discontinuities, jitter, or physically implausible effects. Such constraints help produce output motion sequences that remain smooth and realistic across a range of input conditions and style combinations.

Another technical advantage of some implementations is the application of contrastive loss during training of the diffusion model to align style inputs and motion outputs within a shared embedding space. The formulation strengthens the relationship between corresponding style-motion pairs while separating dissimilar pairs. The resulting trained model provides accurate interpretation of stylistic intent from diverse input formats and consistent generation of stylized motion sequences.

Another technical advantage of some implementations is the application of both classifier-free guidance and classifier-based guidance mechanisms to influence the denoising. In some implementations, classifier-based guidance includes gradient signals derived from a pre-trained feature extractor that evaluates similarity between the current motion representation and the style input. Combined guidance enables more precise control over tradeoffs between content fidelity and style adherence without requiring manual adjustment of model parameters.

Further technical advantages include reduction in inference cost (computational workload imposed by model runs to generate stylized motion sequences) through use of a single-branch network architecture for both content and style. By avoiding redundant encoding paths, implementations reduce usage of computational resources (e.g., in-comparison to multi-branch techniques) while supporting expressive stylization behavior. Such efficiency is particularly beneficial in real-time, near-real-time, or interactive scenarios, including, e.g., avatar motion rendering in virtual environments.

### System Architecture

The present disclosure is directed towards, inter alia, techniques to generate stylized motion sequences using a single-branch diffusion framework that integrates content and style directly within the diffusion, enabling multimodal style conditioning across one or more motion, text, image, video, and/or audio inputs. In some implementations, the techniques utilize one or more of style-content cross fusion, contrastive learning objectives for multimodal alignment, and geometric guidance constraints. In some implementations, style-content cross-normalization enables standardization of feature distributions between content and style inputs.

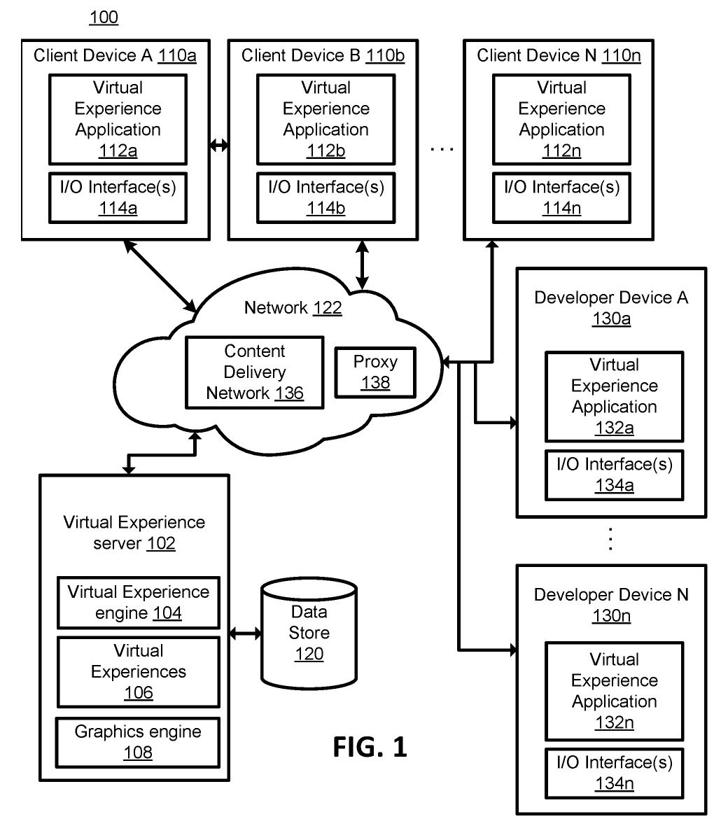

FIG. 1 is a diagram of an example system architecture to generate stylized motion sequences using a diffusion model with style-content cross fusion. FIG. 1 and the other figures use like reference numerals to identify similar elements. A letter after a reference numeral, such as “110," indicates that the text refers specifically to the element having that particular reference numeral. A reference numeral in the text without a following letter, such as "110," refers to any or all of the elements in the figures bearing that reference numeral (e.g. "110" in the text refers to reference numerals “110a," “110b," and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

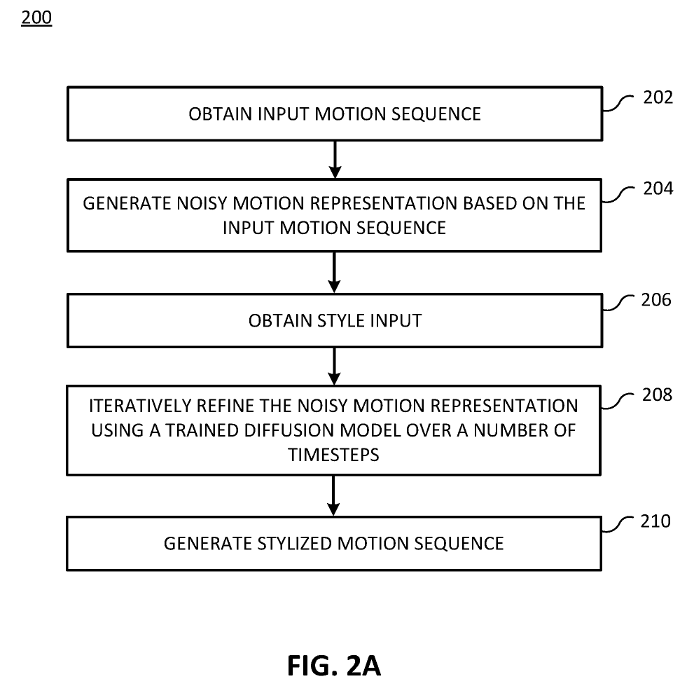

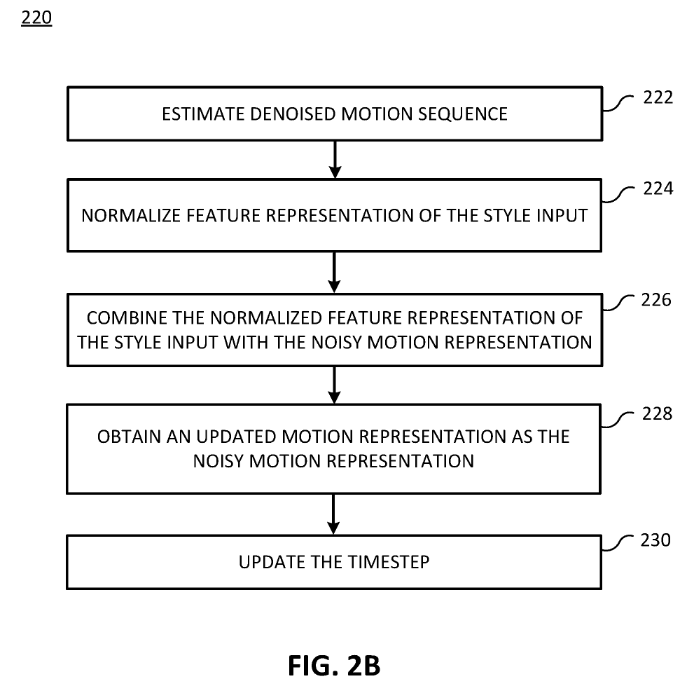

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowcharts shown in FIGS. 2A and FIG. 2B. In one or more additional or alternative implementations, the operations described below may be performed on one or more client devices 110, or one or more developer devices 130. In some implementations, where the operations are performed depends at least in part on computational resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure may include a “user” (e.g., creating user) being an entity controlled by a set of users or an automated source. For example, a set of individual users federated as a community or group in a user-generated content system may be considered a “user.”

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, augmented reality (AR) experiences, or combinations thereof, for example. In some implementations, users may participate in interactions (such as gameplay) with other users. In some implementations, a virtual experience may be experienced in real-time or near-real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. Virtual experience engine 104 implements the techniques described herein. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or avatar position and velocity information, etc.) to the online virtual experience server 102. Subsequent to receiving control instructions from the client devices 110, the online virtual experience server 102 may send experience instructions (e.g., position and velocity information of the avatars participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (i.e., avatar) of the user within the virtual experience. For example, control instructions may include user input to control action within the experience, such as right, left, up, down, user selection, gyroscope position and orientation data, force sensor data, etc. The control instructions may include avatar position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, avatars (or virtual experience objects generally) are constructed from components, one or more of which may be selected by the user, that automatically join together to aid the user in editing.

In some implementations, an avatar is implemented as a 3D model and includes a surface representation used to draw the avatar (also known as a skin or mesh) and a hierarchical set of interconnected bones (also known as a skeleton or rig). The rig may be utilized to animate the avatar and to simulate motion and action by the avatar. The 3D model may be represented as a data structure, and one or more parameters of the data structure may be modified to change various properties of the avatar, e.g., dimensions (height, width, girth, etc.); body type; movement style; number/ type of body parts; proportion (e.g., shoulder and hip ratio); head size; etc.

One or more avatars (also referred to as a “character” or “model” herein) may be associated with a user where the user may control the avatar to enable an interaction of the user with the virtual experience 106.

In some implementations, an avatar may include components such as body parts (e.g., hair, arms, legs, etc.) and accessories (e.g., t-shirt, glasses, decorative images, tools, etc.). In some implementations, body parts of avatars that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may control the scale (e.g., height, width, or depth) of an avatar or the scale of components of an avatar. In some implementations, the user may control the proportions of an avatar (e.g., blocky, anatomical, etc.). It may be noted that in some implementations, an avatar may not include an avatar virtual experience object (e.g., body parts, etc.) but the user may control the avatar (without the avatar virtual experience object) to enable the interaction of the user with the virtual experience (e.g., a puzzle game where there is no rendered avatar game object, but the user still controls an avatar to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish an avatar of a user for view or use by other users of the online virtual experience server 102. In some implementations, creating, modifying, or customizing avatars, other virtual experience objects, virtual experiences 106, or virtual experience environments may be performed by a user using an I/O interface (e.g., developer interface) and with or without scripting (or with or without an application programming interface (API)). It may be noted that for purposes of illustration, avatars are described as having a humanoid form. It may further be noted that avatars may have any form such as a vehicle, animal, animate or inanimate object, or other creative form.

In some implementations, the online virtual experience server 102 may store avatars created by users in the data store 120. In some implementations, the online virtual experience server 102 maintains an avatar catalog and virtual experience catalog that may be presented to users. In some implementations, the virtual experience catalog includes images of virtual experiences stored on the online virtual experience server 102. In addition, a user may select an avatar (e.g., an avatar created by the user or other user) from the avatar catalog to participate in the chosen virtual experience. The avatar catalog includes images of avatars stored on the online virtual experience server 102. In some implementations, one or more of the avatars in the avatar catalog may have been created or customized by the user. In some implementations, the chosen avatar may have avatar settings defining one or more of the components of the avatar.

In some implementations, an avatar of a user can include a configuration of components, where the configuration and appearance of components and more generally the appearance of the avatar may be defined by avatar settings. In some implementations, the avatar settings of an avatar of a user may at least in part be chosen by the user. In other implementations, a user may choose an avatar with default avatar settings or avatar setting chosen by other users. For example, a user may choose a default avatar from an avatar catalog that has predefined avatar settings, and the user may further customize the default avatar by changing some of the avatar settings (e.g., adding a shirt with a customized logo). The avatar settings may be associated with a particular avatar by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual avatar in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual avatar in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual avatar in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual avatar in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more avatars available to participate in one or more virtual experiences 106 of online virtual experience server 102. In some implementations, with credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

In some implementations, the virtual experience server 102 includes a virtual experience engine 104 that executes logic for generating stylized motion sequences based on input motion data, content text prompts, and style inputs. The engine 104 may perform the techniques described herein, such as receiving a noisy motion representation and conditioning inputs, applying iterative refinement using a trained diffusion model, and producing a stylized motion output that reflects both content structure and stylistic modulation. By performing motion generation and style fusion operations server-side, stylized animations can be generated dynamically and delivered to one or more of client devices 110 with low or no computational overhead on the client.

Client devices 110 execute a virtual experience application 112 that receives and renders stylized motion sequences generated by the server. In some implementations, the application 112 may provide content prompts or select style references for animation personalization. The application 112 may cache stylized motion outputs for reuse across avatar animations or interactive experiences. In certain configurations, the client device may apply real-time or near-real-time playback adjustments such as skeletal retargeting or frame-rate interpolation to adapt the stylized motion sequence to device-specific constraints or avatar proportions. In some implementations, the application 112 may perform refinement operations on received motion data, such as local smoothing or adjustments based on motion velocity or acceleration. In some implementations, avatar-specific motion binding and rendering may be performed client-side.

### Generation of Stylized Motion Sequences Using a Diffusion Model with Style-Content Cross Fusion

FIG. 2A is a flow diagram illustrating an example method 200 to provide stylized motion sequences using a diffusion model with style-content cross fusion, in accordance with some implementations. In various implementations, the blocks shown in FIG. 2A and described below may be performed by any of the computing devices illustrated in FIG. 1, e.g., one or more of client devices 110 and/or online virtual experience server 102. For example, two or more client devices 110 may perform method 200, or at least one client device 110 and online virtual experience server 102 may perform method 200. In some implementations, certain blocks of method 200 may be performed by a client device 110 and other blocks of method 200 may be performed by an online virtual experience server 102.

Some implementations described herein may make use of user-provided or user-associated motion data, such as avatar movement sequences, interaction history within a virtual environment, or text (or audio or video) inputs describing motion or other actions. In such cases, data is collected and used only with specific user permission and in accordance with applicable data protection regulations. Identifiable user information is excluded before training data is used to build or improve machine learning models. When data is used for training or evaluation, only de-identified or aggregated motion features are retained. Data is stored for a limited duration consistent with its intended use. Users are provided with control options to manage data sharing preferences, including whether motion data is collected, how it may be used, and the ability to delete previously submitted data.

Method 200 begins at block 202. At block 202, an input motion sequence is obtained that represents a sequence of skeletal poses over a number of frames. As used herein, an input motion sequence includes a digital representation of human or avatar movement encoded over time. Each instance in the sequence corresponds to a frame, where a frame denotes a discrete time step in a temporal sequence, such as those occurring at a sampling rate of 30 frames per second. Each frame includes structured data describing the spatial configuration of a skeletal model at that time step.

As used herein, a sequence of skeletal poses includes a set of joint positions that represent a body pose in each frame. A skeletal pose includes coordinates of anatomical reference points such as hips, knees, shoulders, elbows, and wrists. Each pose is defined as a set of three-dimensional vectors indicating the position of each joint in Cartesian space relative to a coordinate origin.

In some implementations, the input motion sequence may include orientations or rotations of joints, represented using, e.g., Euler angles, quaternions, or rotation matrices. In some implementations, the motion sequence may be derived from motion capture data, pose estimations from video, or keyframe animation sequences. For example, a motion sequence may be extracted from a video of a person walking by applying a pose estimation model to each frame of the video. A sequence of skeletal joint positions is generated, such as the head, torso, arms, and legs, across consecutive time steps.

In some implementations, preprocessing is performed to normalize the input motion sequence. Joint coordinates may be centered on a root joint to remove global translation. Poses may be rotated into a canonical orientation to align characters to a common forward direction. In some implementations, missing or noisy joint data is interpolated or filtered prior to downstream processing.

In some implementations, the number of frames in the input motion sequence may vary depending on the duration of the motion to be modeled. Short sequences may capture discrete gestures, such as waving or pointing, while longer sequences may represent complex activities, such as walking, dancing, or interactive behaviors. In some implementations, frame indexing begins from a defined start point and proceeds in uniform timestep intervals. Block 202 is followed by block 204.

At block 204, a noisy motion representation is generated based on the input motion sequence. As used herein, the noisy motion representation includes a version of the motion data in which visual noise has been added during a sampling operation in a diffusion-based generative framework. The added noise is used to train or condition a diffusion model to recover structured motion content from progressively noisier representations.

The input motion sequence, which includes a sequence of skeletal poses over a number of frames, is encoded into a latent vector format. Each latent vector may encapsulate joint position and orientation information across frames, enabling the motion to be represented compactly in a form suitable for manipulation and learning. A noise function is then applied to the latent representation, where the noise may be sampled from a Gaussian distribution and scaled according to a selected timestep parameter.

The total amount of visual noise applied is a function of the timestep, with higher timestep indices corresponding to greater amounts of noise. For example, at a low timestep index, the latent motion representation may retain its structural characteristics. At a high timestep index, the representation may be visually indistinguishable from random noise. The progressive noising enables the diffusion model to be trained or executed in reverse to predict denoised motion content from input representations at different noise levels.

In some implementations, the application of noise may include spatial or temporal masking to adjust how noise is distributed across different joints or frames. For example, greater noise magnitude may be introduced to peripheral joints, such as the hands or feet, while limiting noise in central joints, such as the pelvis or chest. The noise distribution may be uniform or non-uniform based on pre-specified rules or data-driven patterns. Block 204 is followed by block 206.

At block 206, a style input representing a motion style is obtained. As used herein, the style input defines attributes or characteristics that influence the overall appearance or expressive quality of the output motion. Motion style may refer to tempo, energy, fluidity, rhythm, or other qualitative traits that distinguish how a particular motion is performed.

The style input may include one or more data types selected from the group comprising a style motion sequence, a text prompt, an image, an audio signal, a video clip, and any combination thereof. A style motion sequence may be a pre-recorded series of skeletal poses that reflect a particular style, such as slow and controlled movements or exaggerated high-energy transitions. For example, a style motion sequence may depict the mannerisms associated with a ceremonial procession or the dynamic movements used in a fast-paced combat animation.

In some implementations, the style input includes a natural language text prompt that describes the motion style. The prompt may include adjectives, adverbs, or descriptive phrases. For example, a prompt such as "graceful and deliberate" or "jerky and robotic" may be used to guide the stylization. The language input is embedded into a vector space for conditioning, where semantically related descriptions may be positioned nearby and treated as similar during motion generation.

In some implementations, an image is used to convey contextual or stylistic cues. For example, an image showing a person in a particular costume or pose may be used to guide the style of the output motion. The image may be processed using a visual encoder to produce a style embedding that conditions the motion generation.

An audio signal may serve as a style input. For example, the rhythm and tempo of a musical track can guide the pacing or energy level of the motion sequence. Spectral features such as beat alignment or onset strength may be extracted from the audio and used to modulate motion characteristics. In some implementations, a video clip may be used to provide both motion and visual context, enabling extraction of both temporal and spatial style cues.

In some implementations, multiple style inputs may be combined. For example, a text prompt may be paired with a short audio segment to refine the motion expression. In another example, a text prompt may be paired with an image. In yet another example, an image and a short audio segment may be provided that indicates the target motion expression. The resulting multimodal style representation is used in subsequent operations to condition the generation of the stylized motion sequence. Block 206 is followed by block 208.

At block 208, the noisy motion representation is iteratively refined using a trained diffusion model over a number of timesteps. As used herein, a trained diffusion model includes a generative model that is trained to map noisy data representations to structured outputs by reversing a stochastic noising. During training, the diffusion model is trained to learn a denoising function conditioned on input data such as skeletal poses, style signals, and timestep indices. The diffusion model is trained to apply learned parameters to sequentially remove noise in a latent representation over multiple inference operations. Each of those operations is referred to as a timestep. A timestep corresponds to a discrete stage within the denoising trajectory, where the diffusion model is trained to apply an inference function to progressively move the motion representation toward a plausible output. Iteratively refined indicates that the diffusion model operates in a loop over timesteps, with each iteration receiving the output of the previous timestep as input for the next refinement operation. The number of timesteps may be fixed in advance or determined dynamically, depending on the inference configuration. In some implementations, the number of timesteps is predetermined and fixed during inference (e.g., 100 steps), without adaptive early stopping.

In some implementations, the trained diffusion model used in the iterative refinement operates has a single-branch architecture that processes both content features and style features within a same latent space. A single-branch architecture is a diffusion model design in which both the noisy motion representation and the style input are encoded and manipulated within a unified network path, as opposed to using separate parallel pathways or distinct encoders for different modalities. The feature representations of both content and style are projected into a shared latent space, where transformations such as, e.g., cross fusion, denoising, and timestep-based refinement are performed.

In some implementations, iterative refinement of the noisy motion representation using the trained diffusion model includes applying a geometric guidance constraint that regulates velocity and acceleration values for the denoised motion sequence across timesteps. The geometric guidance constraint operates by incorporating a secondary objective or regularization term into the diffusion model during refinement, configured to limit unrealistic or discontinuous changes in skeletal joint positions between successive frames. For example, if the velocity or acceleration of one or more joints in the denoised motion sequence meets a defined threshold based on training data statistics, the update is performed to provide smoother transitions. The constraint may be implemented using differentiable loss terms such as velocity smoothness penalties or second-order derivative constraints applied to the output sequence. The constraints are evaluated at each timestep using differences in joint position coordinates across temporally adjacent frames.

In some implementations, iterative refinement of the noisy motion representation includes applying a contrastive loss function to regulate the similarity between representations of the style input and the evolving motion output. The contrastive loss function is computed using embedding vectors that represent the style input and motion representations at different stages of the refinement. At a given timestep, an embedding of the updated motion representation is compared to an embedding of the style input to compute a similarity score. A secondary comparison is performed between the embedding of the style input and the embedding of the noisy motion representation from an earlier timestep. The contrastive loss is defined to increase the similarity between the updated motion representation and the style input while decreasing the similarity between the style input and less refined representations. Similarity scores may be determined using distance metrics such as cosine similarity or Euclidean distance in the embedding space. The loss function the refinement path taken by the diffusion model, with the diffusion model being rewarded for outputs that more closely align with the stylistic features present in the input, thereby guiding the diffusion model towards the target output. In some implementations, contrastive loss is applied during the training of style encoders to improve the separability and alignment of style representations across different modalities, such as motion, image, text, and audio. This facilitates effective cross-modal retrieval and consistent style conditioning; The diffusion model itself is trained using a denoising loss between the predicted noise and the true noise added to the latent motion representation at each timestep.

In some implementations, refinement of the noisy motion representation incorporates guidance mechanisms that influence denoising behavior at one or more timesteps. Classifier-free guidance modifies the denoising operation without relying on an external classifier by interpolating between conditional and unconditional model outputs. The conditional output is based on the style input, while the unconditional output is computed by omitting the conditioning input. The difference between the two outputs is scaled and added back to the conditional output to increase the influence of the conditioning signal.

Classifier-based guidance introduces gradient adjustments derived from an external style classifier that evaluates similarity between intermediate outputs and the target style. Both forms of guidance contribute adjustments to the predicted denoised motion sequence before it is used to compute the updated motion representation. The modifications are intended to balance the preservation of structural motion content with adherence to stylistic features derived from the input. In some cases, the two guidance mechanisms are applied jointly, with weights determining their respective influence on the output.

In some implementations, classifier-based guidance is configured to modify the denoising outputs based on gradient signals produced by a pre-trained style feature extractor. The feature extractor receives candidate motion representations generated during intermediate timesteps and computes similarity scores between those representations and the style input. The style input may be provided in any supported modality, including motion sequences, text prompts, or visual inputs, and is mapped into a latent embedding space shared with the intermediate motion representation.

The extractor computes gradients of a similarity-based loss function, such as cosine similarity or contrastive loss, with respect to the denoised motion representation. The resulting gradients are then used to adjust the denoising output to increase alignment with the intended style features. The feature extractor may be trained separately from the diffusion model using a curated dataset of motion-style pairs, and once trained, remains fixed during inference. The guidance is applied on a per-timestep basis during iterative refinement and contributes to the generation of a stylized motion sequence that more closely reflects the characteristics of the style input.

FIG. 2B is a flow diagram illustrating an example method 220 to provide iterative refinement of a noisy motion representation using a trained diffusion model, in accordance with some implementations. In some implementations, method 220 may be utilized to perform iterative refinement at block 208 of method 200 of FIG. 2A. Method 220 begins at block 222.

At block 222, a denoised motion sequence is estimated based on the noisy motion representation, a style input, and a timestep value. The estimation is produced by a trained diffusion model, which is configured to reduce noise across multiple timesteps using conditional inputs. The noisy motion representation corresponds to a version of an input motion sequence that has been altered by random noise. The style input provides information about the intended stylistic attributes of the final motion sequence. The timestep specifies a particular point in the denoising schedule, such that the diffusion model operates differently depending on the current stage of refinement.

The trained diffusion model accepts the noisy motion representation as a primary input, and uses the style input and timestep as conditional variables. The diffusion model generates an estimate of a less noisy version of the motion representation for the given timestep. The structure of the trained diffusion model may include a transformer-based architecture with multiple encoder layers. For each timestep, the diffusion model generates an output motion sequence with reduced noise, conditioned on both the motion content and the target style. The diffusion model output is a denoised motion sequence that incorporates both the structural properties of the original input and the stylistic properties of the conditioning input.

The estimation includes an operation referred to as style-content cross fusion. As used herein, style-content cross fusion includes techniques for combining content features derived from the noisy motion representation with style features derived from the style input. The fusion operation is implemented within the neural network architecture of the trained diffusion model, such as after a designated transformer encoder layer (where a plurality of transformer encoder layers is arranged in series). The fusion is performed so as to modulate the representation of the motion content with stylistic features in a way that is consistent across timesteps.

In some implementations, style-content cross fusion includes a normalization operation followed by a combination operation. During the normalization operation, a feature representation of the style input is normalized using statistics derived from the content representation, which corresponds to the noisy motion representation. In some implementations, the style-content cross fusion includes applying a statistical transformation via cross-normalization between the style input and the noisy motion representation. Cross-normalization includes a transformation in which statistical parameters, such as mean and variance, computed from feature activations of the noisy motion representation are used to normalize the feature representation of the style input.

In the combination operation, the normalized style features are combined with the content features to form a fused representation. The combination may include operations such as addition, concatenation, or learned linear transformations applied across corresponding feature dimensions. For example, a diffusion model may add the normalized style embedding to the content embedding at a shared spatial or temporal resolution, such as per-joint or per-frame in the case of skeletal motion data. The result is a feature representation that carries structural properties from the original motion sequence and stylistic signals from the conditioning input.

In some implementations, the style input used for the style-content cross fusion includes a motion sequence depicting a particular motion style, a text prompt describing the style, or an image or audio signal representative of the style. For example, a style input may include a video clip showing circular arm motions or a text prompt indicating exaggerated posture transitions. The diffusion model transforms the style input into a feature embedding using a style encoder or a shared encoder network. The output of the style encoder serves as the source of the style features used during the normalization and fusion operations. Block 222 is followed by block 224.

At block 224, a feature representation of the style input is normalized based on a feature representation of the noisy motion representation. The style input includes a data input encoding a target motion style. Examples include a motion sequence exemplifying a style, a natural language text prompt such as “gliding movement,” an image depicting a posture associated with a style, an audio segment indicative of rhythmic timing, or a video clip capturing a stylistic gesture. The style input is transformed into a multi-dimensional feature representation using an encoder configured to process the modality of the input.

The noisy motion representation is converted into a feature representation using one or more transformer encoder layers of the trained diffusion model. The feature representation may reflect joint-level pose information, temporal movement characteristics, or latent spatial structure. The feature representation of the noisy motion representation is used as the reference domain for normalization, such that statistics derived from the content motion are used to normalize the feature vector representing the style input.

In some implementations, normalization is carried out by computing statistics over the content-derived feature representation. The statistics may include, for example, per-channel or per-dimension mean and variance values over a temporal sequence or spatial structure. Once computed, the statistics are used to reparameterize the feature representation of the style input. In some implementations, instance-wise normalization is performed, where each dimension of the style input feature vector is adjusted by subtracting the corresponding mean and dividing by the corresponding standard deviation derived from the noisy motion representation.

In some implementations, the normalization may be further parameterized with learned scaling and bias parameters applied after standardization, which enables the trained diffusion model to preserve information relevant to downstream fusion without over-normalizing distinctive stylistic attributes. The resulting normalized style representation preserves semantic content while being adjusted to align numerically with the context of the current noisy motion representation at the active timestep. Block 224 is followed by block 226.

At block 226, the normalized feature representation of the style input is combined with the noisy motion representation. The normalized feature representation is generated from the style input using a normalization operation, such as instance normalization or layer normalization, where the mean and variance statistics are derived from the noisy motion representation. The normalized representation retains the stylistic semantics of the original input while being rescaled to align numerically with the content feature space.

The combination of the normalized style features and the noisy motion representation occurs within the internal architecture of the trained diffusion model. The diffusion model is configured to accept both content and style information in a joint representation space. The combination operation may be implemented using, e.g., concatenation, elementwise addition, gated fusion, or learned projection mechanisms. Each of the techniques produces a unified feature vector or feature tensor that reflects both the stylistic conditioning and the current state of the noisy motion representation. As used herein, a feature vector is a one-dimensional array representing encoded characteristics of a style or motion input, while a feature tensor is a multi-dimensional representation that may capture spatial, temporal, or channel-wise structure across frames or joints.

In one example implementation, the feature tensors of the style input and the noisy motion representation are passed through linear projection layers before being combined. The projection layers may be learned and are used to align the dimensionality and scale of both representations. After projection, the representations may be concatenated along the feature channel dimension and passed through a multi-layer perceptron (MLP) or a transformer block to produce a fused representation. The fused representation is then used in estimating the denoised motion sequence at the given timestep.

In another implementation, the combination is performed using cross-attention, where the normalized style feature acts as a key-value input, and the noisy motion representation serves as the query. The resulting attention output modulates the motion representation based on the stylistic context. The mechanism supports temporal alignment between the style and motion sequences and enables the diffusion model to selectively incorporate style information based on relevance to the current timestep. Block 226 is followed by block 228.

At block 228, an updated motion representation is obtained as the new noisy motion representation, derived from a combination of the denoised motion sequence and a motion representation generated at a previous timestep. The denoised motion sequence corresponds to the estimation of the clean motion signal at the current timestep. The motion representation from the previous timestep serves as the input noisy signal prior to the current refinement. Both representations are used to generate an updated motion representation, which serves as the input for the iteration of the diffusion model at the next timestep.

The update operation may include techniques such as, e.g., weighted averaging, residual addition, or learned interpolation between the current denoised motion sequence and the prior noisy motion representation. For example, in a weighted averaging scheme, a scalar or tensor-based weighting factor determines the influence of each component on the resulting updated representation. The weight may be statically defined, scheduled across timesteps, or dynamically learned during training.

In some implementations, the update operation follows a predefined denoising trajectory, where a noise schedule is applied to transition the motion representation from a high-noise to a low-noise regime. The schedule may follow a linear, cosine, or exponential progression across timesteps, with parameters selected to stabilize the refinement. Each update reflects a partial transition along the trajectory, incorporating guidance from both the style input and prior motion state.

In some implementations, the update procedure for the motion representation may differ during the first timestep of the iterative refinement. If the current timestep is identified as the first in the denoising sequence, the updated motion representation is derived directly from the denoised motion sequence without incorporating any prior motion representation. Because no previous timestep exists from which to retrieve a prior representation, the diffusion model output at the first timestep is used as-is to initialize the updated motion representation. In subsequent timesteps, the updated motion representation may be obtained by applying interpolation, blending, or weighted averaging between the current denoised motion sequence and a prior motion representation from an earlier timestep. Block 228 is followed by block 230.

At block 230, the timestep is updated to advance the iterative refinement of the diffusion model. The timestep variable tracks the current iteration within a predefined sequence of timesteps used for denoising. Updating the timestep includes incrementing an index or decrementing a counter. The updated timestep is used to retrieve the next corresponding noise level, diffusion coefficient, or schedule-dependent parameter for the subsequent refinement operation. The iterative refinement continues until the final timestep is reached, at which point the denoising iterations terminate and the output is selected. In some implementations, the final timestep is predefined and reached after a fixed number of iterations, such that there is no adaptive stopping.

In some implementations, one or more of blocks 222-230 may be performed by one or more server devices, and one or more of blocks 222-230 may be performed by one or more client devices. In some implementations, all of method 220 may be performed by a server device, or by a client device. In some implementations, block 222, block 224, or block 226 may be omitted. In some implementations, one or more of blocks 222-230 may be performed in parallel. In some implementations, blocks 222 and 224 may be performed in parallel. In some implementations, blocks 226 and 228 may be performed in parallel.

Returning to FIG. 2A, block 208 is followed by block 210.

At block 210, a stylized motion sequence is generated by selecting a final motion representation corresponding to a last timestep of the iterative refinement. The term "stylized motion sequence" includes a sequence of skeletal pose data that reflects both the original content of the input motion and the motion style specified by the style input. Each pose in the stylized sequence is defined over a frame index, where each frame includes joint positions or angles consistent with a skeletal model. The stylization is introduced during the denoising operations and accumulated across timesteps such that the final motion reflects temporal and spatial attributes aligned with the style input.

The final motion representation is obtained from the output of the trained diffusion model at the terminal timestep of the iterative refinement. The representation is selected as the terminal state of the noisy motion representation, after denoising iterations have been performed. The output motion is a function of the accumulated denoising transformations applied over the defined sequence of timesteps. Selection of the final representation may include decoding a latent representation into a motion domain, such as through a decoder sub-network, linear projection, or pre-defined inverse mapping if required.

The generated stylized motion sequence is formatted as a sequence of frames, where each frame includes a set of skeletal joint coordinates or other pose descriptors. The number of frames in the sequence generally matches the length of the input motion sequence unless additional interpolation or truncation operations are applied. The output can be structured in formats such as 3D joint trajectories, quaternions, or joint angle vectors depending on the implementation and application context. The structure is compatible with downstream use cases such as animation playback, avatar rendering, or motion classification.

In some implementations, the stylized motion sequence may be post-processed to adjust frame rates, joint continuity, or compatibility with target rendering engines. Post-processing may include one or more of temporal smoothing, motion retargeting to alternate skeletons, and/or scaling of joint displacement magnitudes to fit particular avatar proportions. Such adjustments are external to the diffusion model and do not alter the denoising operations defined with respect to FIGS. 2A and FIG. 2B.

The stylized motion sequence may be generated for a variety of applications. For example, it may be used to synthesize expressive body movements for digital avatars in immersive environments, in video games, in motion picture generation, etc. In another example, stylized outputs may be used to create motion datasets for training downstream classifiers or style transfer models. The stylized sequence can be stored, visualized, or transmitted to other computing environments for further use.

In some implementations, after the stylized motion sequence has been generated from the final motion representation at the last timestep, the stylized motion sequence is provided for use within a virtual environment. A virtual environment may include any computer-generated three-dimensional space configured to simulate physical or conceptual spaces for purposes such as, e.g., gaming, animation, training, simulation, or social interaction. The stylized motion sequence may be applied to animate a digital character or avatar by associating the sequence of skeletal poses with a rigged mesh or visual representation. For example, a stylized motion sequence conveying a particular dance style may be rendered on an avatar in a multiplayer platform or immersive simulation. The provision operation may include transmitting the motion sequence to a rendering engine, storing the motion sequence in a local or network-accessible data store, or streaming the output to a client application for real-time or near-real-time playback.

In some implementations, one or more of blocks 202-210 may be performed by one or more server devices, and one or more of blocks 202-210 may be performed by one or more client devices. In some implementations, all of method 200 may be performed by a server device, or by a client device. In some implementations, one or more of blocks 202-210 may be performed in parallel. For example, in some implementations, blocks 202 and 206 may be performed in parallel.

In various implementations, the techniques described herein may include combinations of one or more features recited in the claims. For example, in some implementations, an input motion sequence is obtained that represents a sequence of skeletal poses over a plurality of frames. A noisy motion representation is generated based on the input motion sequence. A style input representing a motion style is also obtained, where the style input comprises one or more from the group including a style motion sequence, a text prompt, an image, an audio signal, a video clip, and any combination thereof. The noisy motion representation is iteratively refined using a trained diffusion model over a plurality of timesteps. At each timestep, a denoised motion sequence is estimated based on the noisy motion representation, the style input, and the timestep. Estimating the denoised motion sequence includes performing style-content cross fusion, which includes normalizing a feature representation of the style input based on a feature representation of the noisy motion representation, and combining the normalized feature representation of the style input with the noisy motion representation. An updated motion representation is obtained as the noisy motion representation based on the denoised motion sequence and a motion representation obtained at a previous timestep. The timestep is updated, and a stylized motion sequence is generated by selecting a final motion representation corresponding to a last timestep of the iterative refinement. In some implementations, performing the style-content cross fusion includes applying a statistical transformation via cross-normalization between the style input and the noisy motion representation. In some implementations, the trained diffusion model includes a single-branch architecture that processes content and style features within a same latent space.

In some implementations, an input motion sequence is obtained that represents a sequence of skeletal poses over a plurality of frames. A noisy motion representation is generated based on the input motion sequence. A style input representing a motion style is also obtained, where the style input comprises one or more from the group including a style motion sequence, a text prompt, an image, an audio signal, a video clip, and any combination thereof. The noisy motion representation is iteratively refined using a trained diffusion model over a plurality of timesteps. At each timestep, a denoised motion sequence is estimated based on the noisy motion representation, the style input, and the timestep. Estimating the denoised motion sequence includes performing style-content cross fusion, which includes normalizing a feature representation of the style input based on a feature representation of the noisy motion representation, and combining the normalized feature representation of the style input with the noisy motion representation. An updated motion representation is obtained as the noisy motion representation based on the denoised motion sequence and a motion representation obtained at a previous timestep. The timestep is updated, and a stylized motion sequence is generated by selecting a final motion representation corresponding to a last timestep of the iterative refinement. In some implementations, the iterative refinement further includes applying a geometric guidance constraint that regulates velocity and acceleration values for the denoised motion sequence across timesteps. In some implementations, the iterative refinement further includes applying a contrastive loss function, where a similarity score between an embedding of the style input and an embedding of the updated motion representation computed using the loss function is greater than a similarity score between the embedding of the style input and the noisy motion representation. In some implementations, contrastive loss is applied during the training of style encoders to improve the separability and alignment of style representations across different modalities, such as motion, image, text, and audio. This facilitates effective cross-modal retrieval and consistent style conditioning; The diffusion model itself is trained using a denoising loss between the predicted noise and the true noise added to the latent motion representation at each timestep.

In some implementations, an input motion sequence is obtained that represents a sequence of skeletal poses over a plurality of frames. A noisy motion representation is generated based on the input motion sequence. A style input representing a motion style is also obtained, where the style input comprises one or more from the group including a style motion sequence, a text prompt, an image, an audio signal, a video clip, and any combination thereof. The noisy motion representation is iteratively refined using a trained diffusion model over a plurality of timesteps. At each timestep, a denoised motion sequence is estimated based on the noisy motion representation, the style input, and the timestep. Estimating the denoised motion sequence includes performing style-content cross fusion, which includes normalizing a feature representation of the style input based on a feature representation of the noisy motion representation, and combining the normalized feature representation of the style input with the noisy motion representation. An updated motion representation is obtained as the noisy motion representation based on the denoised motion sequence and a motion representation obtained at a previous timestep. The timestep is updated, and a stylized motion sequence is generated by selecting a final motion representation corresponding to a last timestep of the iterative refinement. In some implementations, the iterative refinement further includes modifying denoising outputs at one or more timesteps using classifier-free guidance and classifier-based guidance, where using the guidance adjusts the noisy motion representation to balance content fidelity and adherence to the style input. In some implementations, the classifier-based guidance modifies the denoising outputs based on gradient signals derived from a pre-trained style feature extractor that evaluates similarity to the style input.

In some implementations, an input motion sequence is obtained that represents a sequence of skeletal poses over a plurality of frames. A noisy motion representation is generated based on the input motion sequence. A style input representing a motion style is also obtained, where the style input comprises one or more from the group including a style motion sequence, a text prompt, an image, an audio signal, a video clip, and any combination thereof. The noisy motion representation is iteratively refined using a trained diffusion model over a plurality of timesteps. At each timestep, a denoised motion sequence is estimated based on the noisy motion representation, the style input, and the timestep. Estimating the denoised motion sequence includes performing style-content cross fusion, which includes normalizing a feature representation of the style input based on a feature representation of the noisy motion representation, and combining the normalized feature representation of the style input with the noisy motion representation. An updated motion representation is obtained as the noisy motion representation based on the denoised motion sequence and a motion representation obtained at a previous timestep. The timestep is updated, and a stylized motion sequence is generated by selecting a final motion representation corresponding to a last timestep of the iterative refinement. In some implementations, when the timestep is a first timestep, the updated motion representation is obtained based only on the denoised motion sequence.

In some implementations, an input motion sequence is obtained that represents a sequence of skeletal poses over a plurality of frames. A noisy motion representation is generated based on the input motion sequence. A style input representing a motion style is also obtained, where the style input comprises one or more from the group including a style motion sequence, a text prompt, an image, an audio signal, a video clip, and any combination thereof. The noisy motion representation is iteratively refined using a trained diffusion model over a plurality of timesteps. At each timestep, a denoised motion sequence is estimated based on the noisy motion representation, the style input, and the timestep. Estimating the denoised motion sequence includes performing style-content cross fusion, which includes normalizing a feature representation of the style input based on a feature representation of the noisy motion representation, and combining the normalized feature representation of the style input with the noisy motion representation. An updated motion representation is obtained as the noisy motion representation based on the denoised motion sequence and a motion representation obtained at a previous timestep. The timestep is updated, and a stylized motion sequence is generated by selecting a final motion representation corresponding to a last timestep of the iterative refinement. In some implementations, the stylized motion sequence is provided for use within a virtual environment.

### Training a diffusion model to generate stylized motion sequences

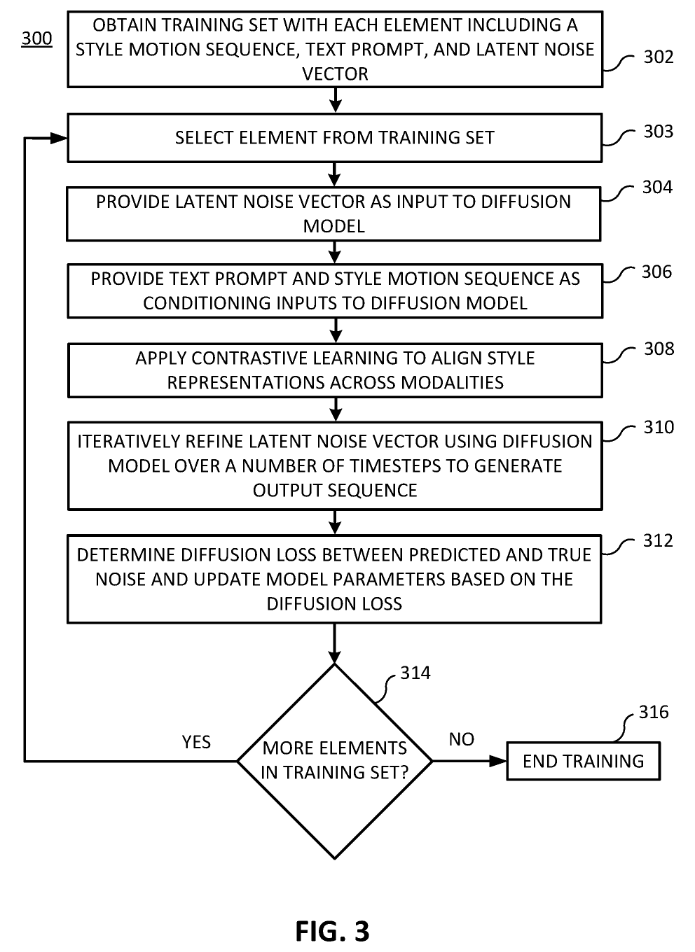

FIG. 3 is a flow diagram illustrating an example method 300 to train a diffusion model to generate motion sequences, in accordance with some implementations. In various embodiments, the blocks shown in FIG. 3 and described below may be performed by any of the elements illustrated in FIG. 1. Method 300 begins at block 302.

At block 302, a training set is obtained. The training set includes a plurality of elements, where each element corresponds to a combination of data items used for supervised or self-supervised training of a diffusion model configured to produce stylized motion sequences. The training data may be pre-processed to enable compatibility with a diffusion model input format, such as converting motion sequences into a skeletal joint representation, encoding textual inputs using a tokenizer, or sampling from precomputed noise distributions for diffusion-based input conditioning.

Each element of the training set includes a style motion sequence that represents a stylized modification of motion. A style motion sequence includes a time-ordered series of skeletal poses or joint configurations that embody a particular motion style. A motion style may refer to attributes such as tempo, expressiveness, rhythm, or cultural context of movement. For example, a style motion sequence may include skeletal data capturing the movements of a traditional folk dance or a smooth walking pattern characterized by exaggerated hip sway. Each frame in the sequence defines joint angles or positions for a character rig at a corresponding time point.

Each element of the training set further includes a text prompt that describes an action corresponding to a content motion sequence. A text prompt is a natural language phrase or sentence such as "bowing to an audience," "picking up an object from the ground," or "greeting with a hand wave." The content motion sequence referred to by the text prompt may be a baseline motion, devoid of stylistic variations, that conveys the underlying action semantics. The inclusion of the text prompt in the training data enables the diffusion model to be trained to associate semantic representations of actions with both content and style during the denoising.

A latent noise vector is included in each training element. The latent noise vector serves as an initial input to the diffusion model and may be sampled from a predefined noise distribution, such as Gaussian noise. The vector resides in a latent space that encodes temporal and spatial information for skeletal motion, and is used as a starting point for iterative denoising. The diffusion model is trained to progressively modify the noise vector such that it converges toward a motion representation matching the style motion sequence conditioned on the style and content inputs.

In some implementations, the training set may be generated by curating motion capture sequences for different styles and actions, pairing them with semantically relevant text descriptions, and sampling multiple noise vectors per sequence to increase data diversity. For example, a single style motion sequence depicting a celebratory gesture can be paired with the text prompt "raising both hands in joy" and multiple distinct noise vectors to create multiple training examples.

In some implementations, the training set may be stored in a structured data format that supports parallel access and batch loading. Each element may include metadata describing, for example, the frame rate, skeleton hierarchy, or actor identity. Block 302 is followed by block 303.

At block 303, an element is selected from the training set. Block 303 is followed by block 304.

At block 304, the latent noise vector is provided as an input to the diffusion model. The latent noise vector is a multi-dimensional representation sampled from a probability distribution such as a Gaussian distribution, and is used to initialize the iterative denoising trajectory within the latent space of the diffusion model. The latent noise vector may encode a temporal sequence corresponding to the number of frames in the target motion sequence, with each timestep including parameters that reflect position, orientation, or velocity of skeletal joints in an abstract representation.

The diffusion model is trained to accept the latent noise vector as one of its primary inputs. The vector serves as the starting point from which the diffusion model is trained to generate intermediate denoised representations by applying a series of learned transformations over multiple timesteps. The architecture of the diffusion model may include transformer blocks, recurrent modules, or convolutional layers that process the noise vector across temporal dimensions while incorporating conditioning inputs such as style and content.

Providing the latent noise vector to the diffusion model does not include any direct reference to the ground truth motion. The diffusion model is configured to transform the input noise toward a motion representation by minimizing an objective function over successive iterations. During training, the noise vectors serve as inputs that map to known stylized motion targets, enabling supervised comparison after inference operations.

In some implementations, the latent noise vector may be scaled or normalized before input to the diffusion model to align with internal latent space constraints. For example, standard score normalization may be applied across features to enable input values to fall within a range expected by the parameter initialization of the diffusion model. Additionally, the vector may be broadcast to match the expected shape for batch-wise inference, with individual elements processed independently across the batch.

Each latent noise vector may correspond to a different initial condition, even when associated with the same style motion sequence and text prompt, enabling the diffusion model to be trained to learn a distribution over valid stylized outputs rather than a single deterministic mapping, which enables different runs starting from different noise vectors to produce stylistically consistent but distinct motion sequences. Block 304 is followed by block 306.

At block 306, the text prompt and the style motion sequence are provided as conditioning inputs to the diffusion model. The conditioning inputs serve to guide the denoising trajectory of the diffusion model such that the generated motion output reflects both the stylistic characteristics of the style motion sequence and the semantic meaning of the text prompt. Conditioning enables the diffusion model to be trained to incorporate auxiliary signals beyond the latent noise vector, shaping the output toward desired properties.

The text prompt comprises a sequence of natural language tokens describing an action, event, or movement category corresponding to a target content motion sequence. For example, a text prompt may include phrases such as “walking with heavy steps,” “gesturing during conversation,” or “picking up an object from a table.” The text is tokenized and embedded into a vector representation using a pre-trained language encoder, such as a transformer-based text model. The resulting embedding captures semantic features of the described action and serves as one component of the conditioning input.

The style motion sequence encodes temporal motion data that reflects the desired motion style. The data may include skeletal pose information across a defined number of frames, with each frame comprising joint positions and orientations. For example, a style motion sequence may correspond to a motion clip exhibiting expressive arm gestures or slow and fluid walking. The style motion sequence is passed through a style encoder to generate a latent representation that captures stylistic attributes in a format compatible with the conditioning mechanism of the diffusion model.

The conditioning inputs may be fused with internal features of the diffusion model using concatenation, attention mechanisms, or learned projection layers. In some implementations, cross-attention is used to inject style and text information into intermediate layers of the diffusion model during each timestep of the denoising, which enables the diffusion model to be trained to dynamically reference conditioning information while processing the latent noise vector over time. Block 306 is followed by block 308.

At block 308, contrastive learning is applied to align style representations across different modalities, such as, e.g., motion, text, image, and audio. The contrastive loss is used to train one or more style encoders such that embeddings derived from inputs with the same semantic style are mapped close together in a shared latent feature space, while embeddings from unrelated inputs are mapped farther apart. For example, embeddings of a style motion sequence and a corresponding text prompt (e.g., “performing a ceremonial bow”) are treated as a positive pair, and embeddings from unrelated pairings (e.g., “throwing a ball” or “marching with high knees”) serve as negative examples.

To compute the contrastive loss, the system uses respective encoders for each modality to transform style inputs into a common embedding space. During training, batches of data are processed to compute distances between embeddings. The contrastive objective reduces the distance between embeddings of positive pairs and increases the distance between embeddings of negative pairs. Negative examples may be drawn from the current training batch or retrieved from an external memory bank. This loss function improves the separability and semantic alignment of style embeddings across modalities, thereby enabling consistent and flexible style conditioning during inference.

The parameters of the encoders are updated based on the computed contrastive loss. In some implementations, this loss is incorporated as part of a composite objective that includes other loss terms (e.g., diffusion denoising loss or reconstruction loss), which are jointly used to update components of the overall training architecture. In some implementations, the contrastive loss is not used to directly train the denoising layers of the diffusion model, but rather to shape the conditioning signals supplied to the diffusion process. Block 308 is followed by block 310.

At block 310, the latent noise vector is iteratively refined using the diffusion model over a number of timesteps to generate an output motion sequence. The refinement operation proceeds through a denoising schedule, where the latent noise vector is progressively updated at each timestep to reduce the level of noise while incorporating conditioning signals, including the style motion sequence and the text prompt. The iterative refinement uses the trained weights of the diffusion model, which are updated during training to minimize reconstruction and contrastive losses.

At each timestep, the diffusion model is trained to estimate a denoised version of the current motion representation, based on the current noisy input, the timestep index, and the conditioning information. The diffusion model outputs either the predicted noise or a clean signal estimate, which is then used to compute an updated motion representation for the next iteration. The scheduling of noise levels across timesteps may follow a linear or cosine schedule or may be learned.

Each latent noise vector represents a point in a high-dimensional space corresponding to motion features. The diffusion model is trained to transform the initial noisy representation into a coherent motion sequence by gradually reducing noise while enforcing consistency with the conditioning inputs. The procedure is repeated for each element in the training set, enabling the diffusion model to be trained to generalize across a diverse set of motion-text-style combinations.

In some implementations, the output motion sequence is generated only at the final timestep, after completing the entire denoising trajectory. The final motion sequence is a sequence of skeletal poses corresponding to the motion style and content described by the conditioning inputs. The generated sequence may be compared against a ground truth style motion sequence to compute a reconstruction loss for training. Block 310 is followed by block 312.

At block 312, a diffusion denoising loss is computed to update parameters of the diffusion model. The denoising loss is determined by comparing the predicted noise generated by the diffusion model at a given timestep to the known noise that was originally added to the ground truth motion sequence. This loss function is applied at each timestep of the iterative refinement process and serves as the primary training signal for the denoising component of the diffusion model.

The diffusion model receives as input a latent motion representation corrupted with noise, along with conditioning signals derived from the style motion sequence and text prompt. At each timestep, the model predicts the noise component that was added. The loss is calculated as the difference between this predicted noise and the actual noise used in the forward diffusion process, e.g., using a mean squared error (MSE) metric or a parameterized variant. The goal of the loss is to enable the model to progressively be trained to reverse the noising process over time.

The computed denoising loss is used to update one or more parameters of the diffusion model via backpropagation. This includes weights in the transformer encoders, attention layers, and other modules responsible for denoising inference. In various implementations, the optimization procedure may use stochastic gradient descent, Adam, or another variant of gradient-based learning, and is applied across minibatches of training samples.

In some implementations, the diffusion denoising loss is combined with one or more auxiliary loss terms, including contrastive loss and motion reconstruction loss, to create a composite objective function. The composite loss balances multiple training goals, including noise prediction accuracy, cross-modal style alignment, and final motion realism. Weighting coefficients may be applied to the individual losses to control their respective influence during optimization. By jointly minimizing this combination of loss functions, the model is trained to denoise accurately while also generating motion sequences that reflect the intended style semantics and content structure. Block 312 is followed by decision point 314.

At decision point 314, it is determined whether there are more elements in the training set. If it is determined that there are more elements, then decision point 314 is followed by block 303, and blocks 303-312 repeat with the next element from the training set. If it is determined that there are no more elements in the training set, then decision point 314 is followed by block 316, where the training of the diffusion model ends.

In some implementations, training a diffusion model to generate stylized motion sequences includes using a training set where each training example contains three elements: a style motion sequence showing how a motion should look in a particular style, a text prompt describing the type of action (such as walking or jumping), and a latent noise vector that serves as the noisy input to the model. For each training example, the model receives the latent noise vector as input, along with the text prompt and the style motion sequence as conditioning inputs. During training, the model is optimized in two ways. First, contrastive learning is applied so that the model learns to associate similar styles—such as text and motion that both describe the same action or expression—more closely than dissimilar ones. Second, the model performs iterative refinement over multiple timesteps to turn the noisy input into a motion output, and then compares the generated motion to the target style motion sequence to calculate a reconstruction loss. The parameters of the model are updated based on this loss so that future outputs better match the expected style.

### Examples of motion-guided stylization

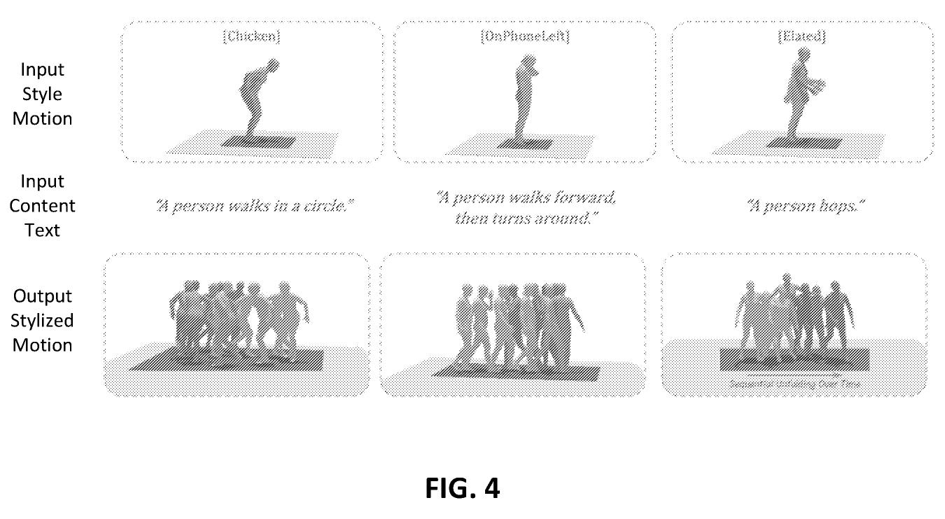

FIG. 4 is a diagram illustrating examples of motion-guided stylization produced by a trained diffusion model, in accordance with some implementations. Each column in the figure corresponds to a distinct stylization scenario composed of three elements: an input style motion, an input content text prompt, and a resulting output stylized motion. The illustration depicts how the diffusion model combines style and content signals to generate temporally coherent and semantically accurate motion sequences that reflect both the prescribed motion behavior and the stylistic cues.

The top row of FIG. 4 shows the input style motion sequences. The sequences represent examples of motion clips associated with identifiable stylistic labels, such as [Chicken], [OnPhoneLeft], and [Elated]. Each style motion input includes a static visualization of the initial pose configuration that characterizes the expressive attributes of the motion. For example, the [Chicken] style depicts hunched posture and inward-pointing elbows, while [Elated] includes outstretched arms and upward body orientation suggestive of exuberance or high energy. The motions provide the diffusion model with style-specific features to condition the denoising trajectory.

The second row of FIG. 4 presents the input content text associated with each stylization task. Each text prompt describes a core action or trajectory that the generated motion reflects. Examples include “A person walks in a circle,” “A person walks forward, then turns around,” and “A person hops.” The language content is used to guide the structural and temporal composition of the generated motion. The prompts are encoded and provided as conditioning inputs during inference to enable the output to retain the semantic meaning of the described action.

The bottom row of FIG. 4 displays the output stylized motion sequences generated by the diffusion model. Each output sequence is depicted as a composite visualization of multiple frames rendered over time, showing the trajectory and joint configurations of the animated figure. In the first column, the diffusion model is trained to generate a motion that maintains the described circular walking trajectory while incorporating stylistic arm and torso movements from the [Chicken] style. In the second column, the diffusion model is trained to synthesize a forward walking motion that includes a turnaround event, with gestures matching the [OnPhoneLeft] style. In the third column, the diffusion model is trained to produce a hopping motion consistent with the input prompt, while adopting posture and limb positioning characteristics from the [Elated] style motion.

The figure visually confirms that the generated motions align with the input text while incorporating stylistic cues from the reference motions. The layered silhouettes in the output visualizations indicate progression through time, enabling temporal dynamics to be inferred from static imagery. The representation emphasizes the capability of the diffusion model to maintain action fidelity (e.g., direction, shape of motion path) and stylistic consistency over the course of the motion sequence.

### Examples of text-guided stylization

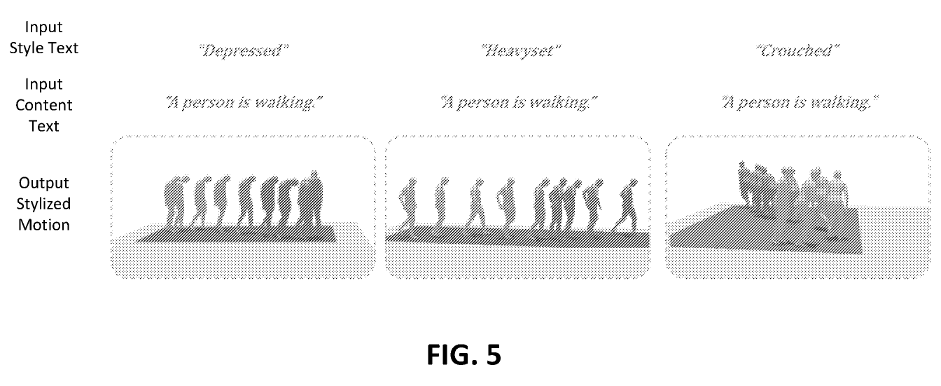

FIG. 5 is a diagram illustrating examples of text-guided motion stylization produced by a trained diffusion model, in accordance with some implementations. The trained diffusion model is trained to generate stylized motion sequences based solely on natural language inputs for both style and content. Each column of the figure corresponds to a separate stylization example and demonstrates how the diffusion model interprets and combines a style description and a content description to produce a motion output that reflects both inputs.

The top row presents the style text inputs, consisting of descriptive phrases such as “Depressed,” “Heavyset,” and “Crouched.” The inputs do not include any motion data; they instead rely on the ability of the diffusion model to be trained to extract style semantics from language. Each style text is encoded using a text encoder, which produces a latent feature representation capturing qualitative aspects of body posture, emotional state, or physical condition implied by the description. The style features are used to modulate the denoising path of the diffusion model during motion generation.

The middle row shows the content text inputs. In all examples in the figure, the content prompt is identical: “A person is walking.” The text defines the intended base action or structure of the resulting motion sequence. The diffusion model is trained to generate a plausible walking motion that maintains alignment with the content description while incorporating the stylistic variations specified in the style text.

The bottom row displays the output stylized motion sequences corresponding to each style-content pair. In the first column, the output motion sequence shows a forward walking motion characterized by downward-facing posture and slumped shoulders, consistent with the “Depressed” style input. In the second column, the output reflects the “Heavyset” style, showing exaggerated weight shifting and wider stance in the walking trajectory. In the third column, the walking motion is executed with a lower center of gravity and bent knees, indicative of the “Crouched” style.

Each output sequence is visualized as a series of temporally overlapping silhouettes, showing body configurations over time. The representation enables the viewer to observe how the diffusion model is trained to integrate stylistic attributes into the progression of the motion sequence without relying on explicit motion examples. The results demonstrate that the diffusion model can be trained to interpret textual descriptions of style and generate motion outputs that are both visually coherent and consistent with the input semantics.

### Examples of style interpretation

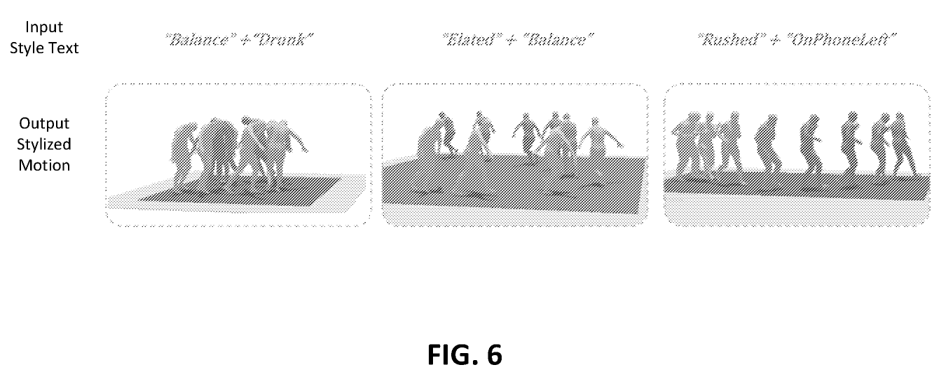

FIG. 6 is a diagram illustrating examples of style interpolation, in which a trained diffusion model generates motion sequences influenced by multiple textual style inputs, in accordance with implementations. The figure illustrates how stylistic attributes from more than one descriptive input can be simultaneously incorporated into a single stylized motion output, demonstrating the capability of the diffusion model to blend multiple conditioning signals in a unified latent space while maintaining the integrity of the motion structure.

The top row of FIG. 6 shows the combinations of style text used for each stylization task. Each example includes two style inputs represented as text phrases joined by a plus symbol. The three style input combinations shown are “Balance” + “Drunk,” “Elated” + “Balance,” and “Rushed” + “OnPhoneLeft.” The inputs are each encoded using a shared text encoder and combined in the conditioning mechanism of the diffusion model to guide the denoising. The goal of the interpolation is to synthesize motion outputs that reflect qualities from both input styles without prioritizing one at the expense of the other.

The bottom row displays the resulting stylized motion outputs. Each output is rendered as a series of temporal silhouettes that visualize the progression of the motion sequence over time. In the first example, the combined influence of “Balance” and “Drunk” results in a motion characterized by unstable but coordinated steps, with shifting weight and irregular limb movements. In the second example, the pairing of “Elated” and “Balance” produces a sequence exhibiting light, upright posture and expressive limb articulation while maintaining grounded foot placement and centered body alignment. In the third example, the combination of “Rushed” and “OnPhoneLeft” generates a forward-driven motion with pronounced leaning and arm positioning suggestive of someone speaking on a phone while moving briskly.

The visualizations demonstrate that the diffusion model can be trained to interpret and combine semantic elements of each style input and generate corresponding physical attributes in the motion output. The layered silhouettes reveal that the resulting trajectories are temporally coherent and that the influence of both styles is maintained throughout the motion sequence.

### Examples of multimodal motion stylization

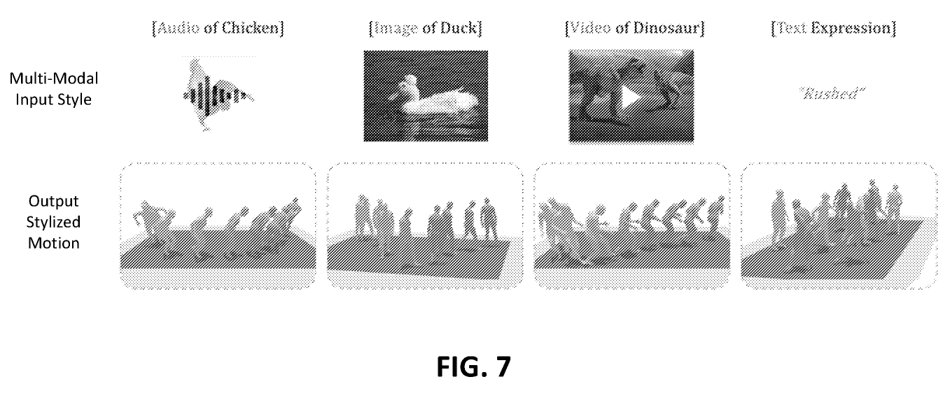

FIG. 7 is a diagram illustrating examples of multimodal motion stylization, where a trained diffusion model is trained to generate stylized motion sequences based on diverse types of style input, in accordance with some implementations. The figure demonstrates that the diffusion model supports input modalities including, e.g., audio, image, video, and text, and can use each to influence the generation of stylized motion outputs while preserving the underlying motion structure.

The top row shows four distinct multimodal style inputs. The first example uses an audio input labeled [Audio of Chicken], representing an auditory signal associated with the movement or behavior of a chicken. The second example provides a still image [Image of Duck], which may imply specific visual features or postural cues. The third example uses a short video clip [Video of Dinosaur], providing dynamic visual motion as a stylistic reference. The fourth example provides a textual descriptor [Text Expression] with the phrase “Rushed,” encoding motion urgency or pacing as linguistic input. Each modality is processed by a corresponding encoder—audio encoder, image encoder, video encoder, or text encoder—to extract style embeddings used as conditioning signals during the diffusion.

The bottom row displays the output stylized motion sequences generated by the diffusion model for each multimodal input. In each case, the output motion reflects characteristics associated with the input style modality while maintaining coherent temporal motion aligned with content structure. The first output, conditioned on chicken audio, includes erratic and upright movement patterns suggestive of bird-like behavior. The second output, guided by the image of a duck, shows waddling or broad stance characteristics. The third output, associated with the dinosaur video, exhibits heavy steps and extended upper body gestures. The final output, conditioned on the word “Rushed,” displays rapid forward movement and aggressive pacing.

Each motion sequence is visualized using overlaid silhouettes rendered sequentially over time, enabling visual inspection of changes in body posture and limb dynamics throughout the animation. The depiction illustrates how the diffusion model is trained to modulate motion generation in response to different style representations.

### Example architecture of trained diffusion model

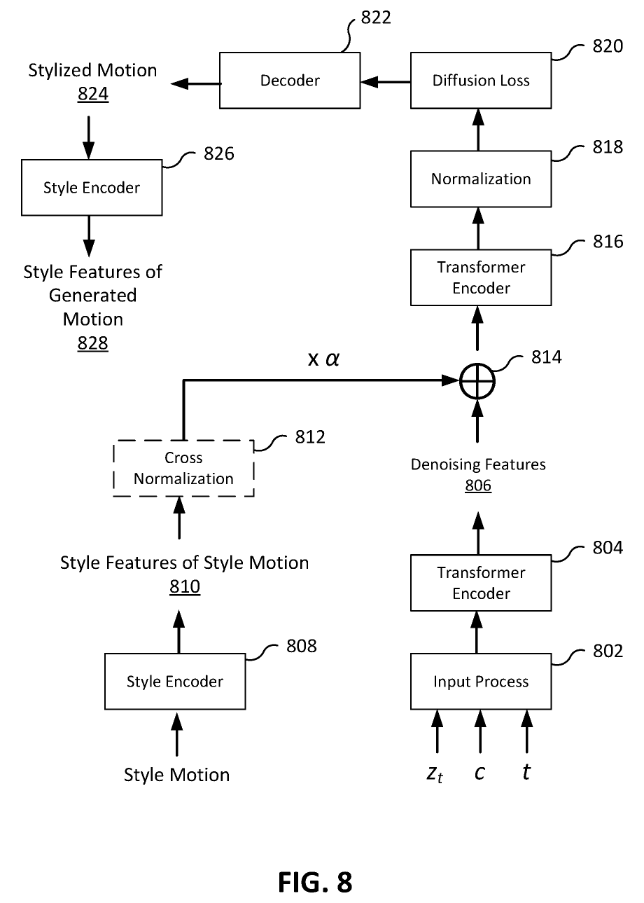

FIG. 8 is a diagram illustrating an example architecture of a trained diffusion model configured to generate stylized motion sequences based on style and content inputs, in accordance with some implementations. The architecture supports conditioning on motion style while preserving motion content through a multi-stage transformation and fusion. Each block in the figure is annotated with a reference numeral indicating a functional module or processing operation used during inference or training.

At block 802, an input process receives a noisy latent motion representation zₜ, a content prompt c, and a timestep index t. The inputs are pre-processed and encoded into a structured format compatible with the transformer encoder at block 804. The transformer encoder at block 804 computes denoising features 806. The denoising features represent content-aware temporal embeddings for the motion representation at the current timestep.

At block 808, a style encoder processes a style motion input to generate style features 810 of the style motion. The style features of the style motion serve as the source of stylistic information for the diffusion model. At block 812, a cross-normalization operation is performed, where the style features are normalized using statistics computed from the denoising features 806, which results in a style representation that is aligned to the feature distribution of the denoising trajectory.

At element 814, the normalized style features are scaled by a factor α and fused with the denoising features, followed by further processing through another transformer encoder at block 816. Block 818 applies a normalization layer, and block 820 computes a diffusion loss based on the difference between the predicted and target outputs. The updated representation is passed to a decoder at block 822.

The decoder at block 822 outputs the final stylized motion sequence 824. To evaluate style alignment, the stylized motion is passed through a secondary style encoder at block 826. The encoder extracts style features 828 from the generated motion, which may be used for auxiliary loss computation or qualitative evaluation.

### Computing device

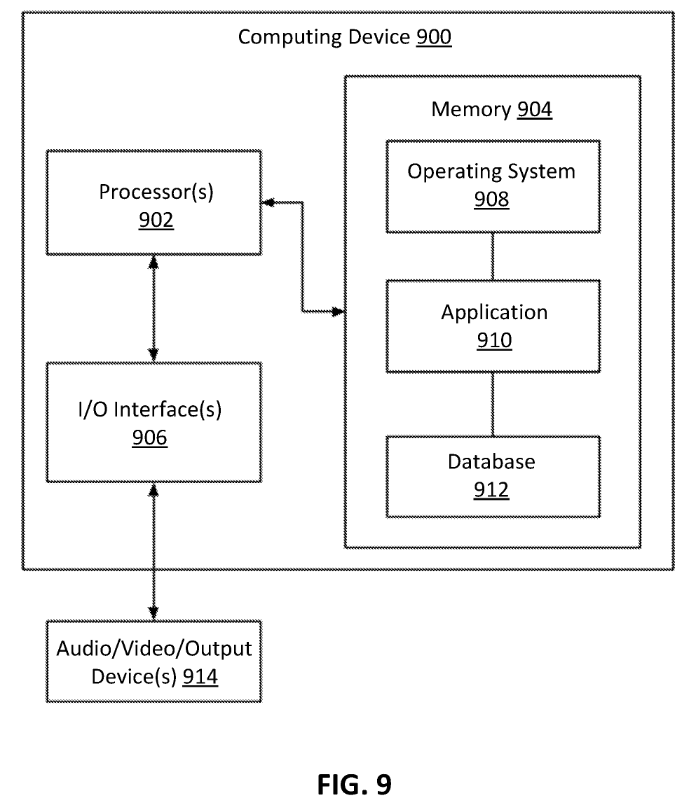

FIG. 9 is a block diagram of an example computing device 900 which may be used to implement one or more techniques described herein. In one example, device 900 may be used to implement a computer device (e.g., 102 and/or 110 of FIG. 1), and perform method implementations described herein. Computing device 900 can be any suitable computer system, server, or other electronic or hardware device. For example, the computing device 900 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 900 includes a processor 902, a memory 904, input/output (I/O) interface 906, and audio/video input/output devices 914.

Processor 902 can be one or more processors and/or processing circuits to execute program code and control basic operations of the device 900. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “near-real-time”, “offline,” in a “batch mode,” etc. Portions of processing may be performed at different times and at different locations, by different (or the same) processing systems. A computer may be any processor in communication with a memory.

Memory 904 is provided in device 900 for access by the processor 902, and may be any suitable computer-readable or processor-readable storage medium, e.g., random access memory (RAM), read-only memory (ROM), Electrical Erasable Read-only Memory (EEPROM), Flash memory, etc., suitable for storing instructions for execution by the processor, and located separate from processor 902 and/or integrated therewith. Memory 904 can store software operating on the server device 900 by the processor 902, including an operating system 907, one or more applications 910, and a database 912 that may store data used by the components of device 900.

Database 912 may store one or more mechanisms, including motion sequence data, style conditioning parameters, and configurations for iteratively refining motion representations using a diffusion model. In some implementations, database 912 may store information associated with motion sequences, such as unique identifiers for each sequence, metadata describing skeletal poses and movement characteristics, and data representing motion transformations across timesteps. The stored data can include, e.g., historical motion representations, precomputed style embeddings, and specific versions of motion sequences used during iterative refinement. For example, in a motion synthesis environment, the database might store both the initial noisy motion representations and their corresponding refined outputs, indicating how the diffusion progressively modified the motion features. In some implementations, database 912 may store other data relevant to motion generation, such as timestep schedules, style-content cross fusion parameters, and session information for managing multimodal conditioning inputs. Applications 910 can include instructions that enable processor 902 to execute the described techniques, such as applying diffusion-based motion refinement, processing style inputs, and generating stylized motion sequences for use in virtual environments.

For example, applications 910 can include a module that implements one or more techniques or services described herein, such as processing an input motion sequence for stylization, applying multimodal style conditioning, or iteratively refining motion representations using a trained diffusion model. Applications 910 can incorporate real-time or near-real-time updates that adjust motion refinement parameters based on dynamic style inputs. The applications may employ various mechanisms to enhance motion generation quality, including applying geometric guidance constraints to regulate velocity and acceleration, using style-content cross fusion to enable coherence between style and motion features, and dynamically adjusting timestep weighting to balance structural preservation and stylistic transformation. Database 912 (and/or other connected storage) can store various data used in the described techniques, including motion sequence identifiers, historical refinement records, style conditioning parameters, and model-specific configurations for controlling diffusion-based motion synthesis.

Elements of software in memory 904 can alternatively be stored on any other suitable storage location or computer-readable medium. In addition, memory 904 (and/or other connected storage device(s)) can store instructions and data used in the features described herein. Memory 904 and any other type of storage (magnetic disk, optical disk, magnetic tape, or other tangible media) can be considered "storage" or "storage devices."

I/O interface 906 can provide functions to enable interfacing the server device 900 with other systems and devices. For example, network communication devices, storage devices (e.g., memory and/or data store 120), and input/output devices can communicate via interface 906. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 914 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 9 shows one block for each of processor 902, memory 904, I/O interface 906, and software blocks of operating system 908 and virtual experience application 910. The blocks may represent one or more processors or processing circuitries, operating systems, memories, I/O interfaces, applications, and/or software engines. In other implementations, device 900 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 900 can be a server device or client device. Example client devices or user devices can be computer devices including some similar components as the device 900, e.g., processor(s) 902, memory 904, and I/O interface 906. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 914, for example, can be connected to (or included in) the device 900 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
obtaining an input motion sequence that represents a sequence of skeletal poses over a plurality of frames;
generating a noisy motion representation based on the input motion sequence;
obtaining a style input representing a motion style, wherein the style input comprises one or more from the group comprising a style motion sequence, a text prompt, an image, an audio signal, a video clip, and any combination thereof;
iteratively refining the noisy motion representation using a trained diffusion model over a plurality of timesteps, wherein the iterative refinement comprises, at each timestep:
estimating, by the trained diffusion model, a denoised motion sequence based on the noisy motion representation, the style input, and the timestep, wherein estimating the denoised motion sequence comprises performing style-content cross fusion, the style-content cross fusion comprising:
normalizing a feature representation of the style input based on a feature representation of the noisy motion representation; and
combining the normalized feature representation of the style input with the noisy motion representation;
obtaining an updated motion representation as the noisy motion representation based on the denoised motion sequence and a motion representation obtained at a previous timestep; and
updating the timestep; and
generating a stylized motion sequence by selecting a final motion representation corresponding to a last timestep of the iterative refinement.

2. The computer-implemented method of claim 1, wherein performing the style-content cross fusion comprises applying a statistical transformation via cross-normalization between the style input and the noisy motion representation.

3. The computer-implemented method of claim 1, wherein the trained diffusion model comprises a single-branch architecture that processes content and style features within a same latent space.

4. The computer-implemented method of claim 1, wherein iteratively refining the noisy motion representation further comprises applying a geometric guidance constraint that regulates velocity and acceleration values for the denoised motion sequence across timesteps.

5. The computer-implemented method of claim 1, wherein iteratively refining the noisy motion representation further comprises applying a contrastive loss function, wherein a similarity score between an embedding of the style input and an embedding of the updated motion representation computed using the loss function is higher than a similarity score between the embedding of the style input and the noisy motion representation.

6. The computer implemented method of claim 1, wherein iteratively refining the noisy motion representation further comprises modifying denoising outputs at one or more timesteps using classifier-free guidance and classifier-based guidance, wherein using the guidance adjusts the noisy motion representation to balance content fidelity and adherence to the style input.

7. The computer-implemented method of claim 6, wherein the classifier-based guidance modifies the denoising outputs based on gradient signals derived from a pre-trained style feature extractor that evaluates similarity to the style input.

8. The computer-implemented method of claim 1, wherein, if the timestep is a first timestep, obtaining the updated motion representation is based only on the denoised motion sequence.

9. The computer-implemented method of claim 1, further comprising:
providing the stylized motion sequence for use within a virtual environment.

10. A computing device comprising:
one or more processors; and
memory coupled to the one or more processors with instructions stored thereon that, when executed by the one or more processors, cause the one or more processors to perform operations comprising:
obtaining an input motion sequence that represents a sequence of skeletal poses over a plurality of frames;
generating a noisy motion representation based on the input motion sequence;
obtaining a style input representing a motion style, wherein the style input comprises one or more from the group comprising a style motion sequence, a text prompt, an image, an audio signal, a video clip, and any combination thereof;
iteratively refining the noisy motion representation using a trained diffusion model over a plurality of timesteps, wherein the iterative refinement comprises, at each timestep:
estimating, by the trained diffusion model, a denoised motion sequence based on the noisy motion representation, the style input, and the timestep, wherein estimating the denoised motion sequence comprises performing style-content cross fusion, the style-content cross fusion comprising:
normalizing a feature representation of the style input based on a feature representation of the noisy motion representation; and
combining the normalized feature representation of the style input with the noisy motion representation;
obtaining an updated motion representation as the noisy motion representation based on the denoised motion sequence and a motion representation obtained at a previous timestep; and
updating the timestep; and
generating a stylized motion sequence by selecting a final motion representation corresponding to a last timestep of the iterative refinement.

11. The computing device of claim 10, wherein performing the style-content cross fusion comprises applying a statistical transformation via cross-normalization between the style input and the noisy motion representation.

12. The computing device of claim 10, wherein the trained diffusion model comprises a single-branch architecture that processes content and style features within a same latent space.

13. The computing device of claim 10, wherein iteratively refining the noisy motion representation further comprises applying a geometric guidance constraint that regulates velocity and acceleration values for the denoised motion sequence across timesteps.

14. The computing device of claim 10, wherein iteratively refining the noisy motion representation further comprises applying a contrastive loss function, wherein a similarity score between an embedding of the style input and an embedding of the updated motion representation computed using the loss function is higher than a similarity score between the embedding of the style input and the noisy motion representation.

15. The computing device of claim 10, wherein iteratively refining the noisy motion representation further comprises modifying denoising outputs at one or more timesteps using classifier-free guidance and classifier-based guidance, wherein using the guidance adjusts the noisy motion representation to balance content fidelity and adherence to the style input.

16. A non-transitory computer-readable medium with instructions stored thereon that, when executed by a processor, cause the processor to perform operations comprising:
obtaining an input motion sequence that represents a sequence of skeletal poses over a plurality of frames;
generating a noisy motion representation based on the input motion sequence;
obtaining a style input representing a motion style, wherein the style input comprises one or more from the group comprising a style motion sequence, a text prompt, an image, an audio signal, a video clip, and any combination thereof;
iteratively refining the noisy motion representation using a trained diffusion model over a plurality of timesteps, wherein the iterative refinement comprises, at each timestep:
estimating, by the trained diffusion model, a denoised motion sequence based on the noisy motion representation, the style input, and the timestep, wherein estimating the denoised motion sequence comprises performing style-content cross fusion, the style-content cross fusion comprising:
normalizing a feature representation of the style input based on a feature representation of the noisy motion representation; and
combining the normalized feature representation of the style input with the noisy motion representation;
obtaining an updated motion representation as the noisy motion representation based on the denoised motion sequence and a motion representation obtained at a previous timestep; and
updating the timestep; and
generating a stylized motion sequence by selecting a final motion representation corresponding to a last timestep of the iterative refinement.

17. The non-transitory computer-readable medium of claim 16, wherein performing the style-content cross fusion comprises applying a statistical transformation via cross-normalization between the style input and the noisy motion representation.

18. The non-transitory computer-readable medium of claim 16, wherein the trained diffusion model comprises a single-branch architecture that processes content and style features within a same latent space.

19. The non-transitory computer-readable medium of claim 16, wherein iteratively refining the noisy motion representation further comprises applying a geometric guidance constraint that regulates velocity and acceleration values for the denoised motion sequence across timesteps.

20. The non-transitory computer-readable medium of claim 16, wherein iteratively refining the noisy motion representation further comprises applying a contrastive loss function, wherein a similarity score between an embedding of the style input and an embedding of the updated motion representation computed using the loss function is higher than a similarity score between the embedding of the style input and the noisy motion representation.
